(19) United States
(12) Patent Application Publication
(10) Pub. No.: US 2022/0279056 A1
(43) Pub. Date: Sep. 1, 2022

(54) Mechanism for Provisioning Source IP for Tunneled Packets From User Plane

(71) Applicant: Parallel Wireless, Inc., Nashua, NH (US)

(72) Inventors: Ganesh Jaju, Pune (IN); Ketan Parikh, Pune (IN); Nikhil Agarwal, Pune (IN)

(21) Appl. No.: 17/683,326

(22) Filed: Feb. 28, 2022

Related U.S. Application Data
(60) Provisional application No. 63/154,601, filed on Feb. 26, 2021.

(51) Int. Cl. H04L 69/22; H04L 12/66; H04W 28/06

(52) U.S. Cl. CPC H04L 69/22; H04L 12/66; H04W 28/06; H04W 88/16

(57) ABSTRACT

Methods and computer readable medium are disclosed for providing an outer header for a packet. In one embodiment a method includes receiving an outer header creation IE type encoded and containing instructions to create an outer header, an outer header creation description field taking a form of a bitmask, each bit indicating the outer header to be created in the outgoing packet; wherein when the outer header creation packet creation IE requests creation of an IP header, a source IP address is included in an IP header of an outgoing packet; and sending the outgoing packet including a source IP in the newly added outer IP header.

### CROSS-REFERENCE TO RELATED APPLICATIONS

This application claims priority under 35 U.S.C. § 119(e) to U.S. Provisional Pat. App. No. 63/154,601, filed Feb. 26, 2021, titled “Mechanism for Provisioning Source IP for Tunneled Packets From User Plane,” which is hereby incorporated by reference in its entirety for all purposes. This application also hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1 in their entirety.

### BACKGROUND

There are two technical specifications relevant to the present disclosure. One is 29.244-3rd Generation Partnership Project; Technical Specification Group Core Network and Terminals; and Interface between the Control Plane and the User Plane Nodes; and 2. 29.214-3rd Generation Partnership Project; Technical Specification Group Services and System Aspects; Architecture; each of which is hereby incorporated by reference for all purposes.

Traditional systems for forwarding a packet received on a PFCP session involve the following. Currently, when a packet is received by a node, it matches the packet to first find the Packet Forwarding control Protocol (PFCP) session. Once the PFCP session is found, it is used to find the matching Packet Detection Rule (PDR) using precedence and direction of the packet. Once the matching PDR is determined, that along with its relevant Forwarding Action Rule (FAR) would dictate any header removal and header addition to be performed on the packet respectively. Then, the packet is sent out using the newly formed optional headers, if any.

### SUMMARY

A method is disclosed for provisioning source IP for tunneled packets from user plane. An Outer Header Creation IE type is encoded and contains the instructions to create an Outer Header. The Outer Header Creation Description field takes the form of a bitmask where each bit indicates the outer header to be created in the outgoing packet. Spare bits shall be ignored by the receiver.

### BRIEF DESCRIPTION OF THE DRAWINGS

FIG. 1 is a flow diagram of a method for provisioning source IP for tunneled packets from user plane, in accordance with some embodiments.

FIG. 2 is a schematic network architecture diagram for 3G and other-G prior art networks.

FIG. 3 is an enhanced eNodeB for performing the methods described herein, in accordance with some embodiments.

FIG. 4 is a coordinating server for providing services and performing methods as described herein, in accordance with some embodiments.

### DETAILED DESCRIPTION

The Outer Header Creation IE type shall be encoded as shown in Table 1. It contains the instructions to create an outer header.

TABLE 1

| | Bits | | | | | | | |
|---|---|---|---|---|---|---|---|---|
| Octets | 8 | 7 | 6 | 5 | 4 | 3 | 2 | 1 |

| | |
|---|---|
| 1 to 2 | Type = 84 (decimal) |
| 3 to 4 | Length = n |
| 5 to 6 | Outer Header Creation Description |
| m to (m + 3) | TEID |
| p to (p + 3) | IPv4 Address |
| q to (q + 15) | IPv6 Address |
| r to (r + 1) | Port Number |
| t to (t + 2) | C-TAG |
| u to (u + 2) | S-TAG |
| s to (n + 4) | These octet(s) is/are present only if explicitly specified |

The Outer Header Creation Description field, when present, shall be encoded as specified in Table 1. It takes the form of a bitmask where each bit indicates the outer header to be created in the outgoing packet. Spare bits shall be ignored by the receiver.

TABLE 2
outer header creation description.

| Octet/Bit | Outer Header to be created in the outgoing packet |
|---|---|
| 5/1 | GTP-U/UDP/IPv4 (NOTE 1), (NOTE 3) |
| 5/2 | GTP-U/UDP/IPv6 (NOTE 1), (NOTE 3) |
| 5/3 | UDP/IPv4 (NOTE 2, NOTE 5) |
| 5/4 | UDP/IPv6 (NOTE 2, NOTE 5) |
| 5/5 | IPv4 (NOTE 5) |
| 5/6 | IPv6 (NOTE 5) |
| 5/7 | C-TAG (see NOTE 4) |
| 5/8 | S-TAG (see NOTE 4) |

NOTE 1:
The SGW-U/I-UPF shall also create GTP-U extension header(s) if any has been stored for this packet, during a previous outer header removal (see clause 8.2.64).
NOTE 2:
This value may apply to UL packets sent by a PGW-U for non-IP PDN connections with SGi tunnelling based on UDP/IP encapsulation (see clause 4.3.17.8.3.3.2 of 3GPP TS 23.401 [14]).
NOTE 3:
The SGW-U/I-UPF shall set the GTP-U message type to the value stored during the previous outer header removal.
NOTE 4:
This value may apply to UL packets sent by a UPF for Ethernet PDU sessions over N6 (see clause 5.8.2.11.6 of 3GPP TS 23.501 [28]).
NOTE 5:
This value may apply e.g. to UL packets sent by a UPF (PDU Session Anchor) over N6, when explicit N6 traffic routing information is provided to the SMF (see clause 5.6.7 of 3GPP TS 23.501 [28]).

At least one bit of the Outer Header Creation Description field shall be set to 1. Bits 5/1 and 5/2 may both be set to 1 if an F-TEID with both an IPv4 and IPv6 addresses has been assigned by the GTP-U peer. In this case, the UP function shall send the outgoing packet towards the IPv4 or IPv6 address.

The TEID field shall be present if the Outer Header Creation Description requests the creation of a GTP-U header. Otherwise it shall not be present. When present, it shall contain the destination GTP-U TEID to set in the GTP-U header of the outgoing packet.

The IPv4 Address field shall be present if the Outer Header Creation Description requests the creation of an IPv4 header. Otherwise it shall not be present. When present, it shall contain the destination IPv4 address to set in the IPv4 header of the outgoing packet.

The IPv6 Address field shall be present if the Outer Header Creation Description requests the creation of an IPv6 header. Otherwise it shall not be present. When present, it shall contain the destination IPv6 address to set in the IPv6 header of the outgoing packet.

The Port Number field shall be present if the Outer Header Creation Description requests the creation of a UDP/IP header (i.e. it is set to the value 4). Otherwise it shall not be present. When present, it shall contain the destination Port Number to set in the UDP header of the outgoing packet.

The C-TAG field shall be present if the Outer Header Creation Description requests the setting of the C-Tag in Ethernet packet. Otherwise it shall not be present. When present, it shall contain the destination Customer-VLAN tag to set in the Customer-VLAN tag header of the outgoing packet.

The S-TAG field shall be present if the Outer Header Creation Description requests the setting of the S-Tag in Ethernet packet. Otherwise it shall not be present. When present, it shall contain the destination Service-VLAN tag to set in the Service-VLAN tag header of the outgoing packet.

Current specifications indicate methods for adding additional header via FAR. But, if such a process results in additional IP header to be added to the packet, it does not dictate the source IP address to be used in this additional IP header.

This has following implications when we consider SGW and PGW nodes.

SGW Uplink Packet

When an uplink GTPU packet is received on SGW S1U interface, it is supposed to be forwarded to PGW's S5U Ingress interface using SGW's S5U Egress interface.

Current mechanism of PFCP session matching would result in an uplink SGW PDR matching the SGW's S1U interface to be selected for uplink traffic. This PDR would have “Outer Header Removal” set and the corresponding FAR having “Outer Header Creation” with GTPU header details for the PGW's S5U Ingress interface.

So, this would result in a new IP header to be added for GTPU header for which the source IP to be used is not provided by Control Plane (CP). Ideally, the source IP for this outer IP header should be that of SGW's S5U Egress interface.

SGW Downlink Packet

When a downlink GTPU packet is received on SGW S5U Egress interface, it is supposed to be forwarded to eNodeB's S1U Ingress interface using SGW's S1U Ingress interface.

Current mechanism of PFCP session matching would result in a downlink SGW PDR matching the SGW's S5U Egress interface to be selected for downlink traffic. This PDR would have “Outer Header Removal” set and the corresponding FAR having “Outer Header Creation” with GTPU header details for the eNodeB's S1U Ingress interface.

So, this would result in a new IP header to be added for GTPU header for which the source IP to be used is not provided by CP. Ideally, the source IP for this outer IP header should be that of SGW's S1U Ingress interface.

PGW Downlink Packet

When an IP packet is received on PGW's SGi interface, it is used to identify the PFCP session and later based on precedence used to find the PGW downlink PDR to be used to forward the packet to SGW.

Such a downlink PGW PDR's corresponding FAR would have “Outer Header Creation” with GTPU header details for the SGW's S5U Egress interface.

So, this would result in a new IP header to be added for GTPU header for which the source IP to be used is not provided by CP. Ideally, the source IP for this outer IP header should be that of PGW's S5U Ingress interface.

One solution to above problems is having a source IP field in the FAR's Outer Header Creation IE.

The Outer Header Creation IE type shall be encoded as shown in Table 3. It contains the instructions to create an Outer Header.

TABLE 3

| | Bits | | | | | | | |
|---|---|---|---|---|---|---|---|---|
| Octets | 8 | 7 | 6 | 5 | 4 | 3 | 2 | 1 |

| | |
|---|---|
| 1 to 2 | Type = 84 (decimal) |
| 3 to 4 | Length = n |
| 5 to 6 | Outer Header Creation Description |
| m to (m + 3) | TEID |
| k to (k + 3) | Source IPv4 Address |
| l to (l + 15) | Source IPv6 Address |
| p to (p + 3) | IPv4 Address |
| q to (q + 15) | IPv6 Address |
| r to (r + 1) | Port Number |
| t to (t + 2) | C-TAG |
| u to (u + 2) | S-TAG |
| s to (n + 4) | These octet(s) is/are present only if explicitly specified |

The Source IPv4 Address field shall be present if the Outer Header Creation Description requests the creation of an IPv4 header. Otherwise it shall not be present. When present, it shall contain the source IPv4 address to set in the IPv4 header of the outgoing packet.

The Source IPv6 Address field shall be present if the Outer Header Creation Description requests the creation of an IPv6 header. Otherwise it shall not be present. When present, it shall contain the source IPv6 address to set in the IPv6 header of the outgoing packet.

This solves the above-mentioned issues in following manner:

SGW uplink packet. When an uplink GTPU packet is received on SGW S1U interface, it is supposed to be forwarded to PGW's S5U Ingress interface using SGW's S5U Egress interface. Current mechanism of PFCP session matching would result in an uplink SGW PDR matching the SGW's S1U interface to be selected for uplink traffic. This PDR would have “Outer Header Removal” set and the corresponding FAR having “Outer Header Creation” with GTPU header details for the PGW's S5U Ingress interface. Since source IP is also mentioned in the “Outer Header Creation”, it is used as source IP in the newly added Outer IP header.

SGW downlink packet. When a downlink GTPU packet is received on SGW S5U Egress interface, it is supposed to be forwarded to eNodeB's S1U Ingress interface using SGW's S1U Ingress interface. Current mechanism of PFCP session matching would result in a downlink SGW PDR matching the SGW's S5U Egress interface to be selected for downlink traffic. This PDR would have “Outer Header Removal” set and the corresponding FAR having “Outer Header Creation” with GTPU header details for the eNodeB's S1U Ingress interface. Since source IP is also mentioned in the “Outer Header Creation”, it is used as source IP in the newly added Outer IP header.

PGW downlink packet. When an IP packet is received on PGW's SGi interface, it is used to identify the PFCP session and later based on precedence used to find the PGW downlink PDR to be used to forward the packet to SGW. Such a downlink PGW PDR's corresponding FAR would have “Outer Header Creation” with GTPU header details for the SGW's S5U Egress interface. Since source IP is also mentioned in the “Outer Header Creation”, it is used as source IP in the newly added Outer IP header.

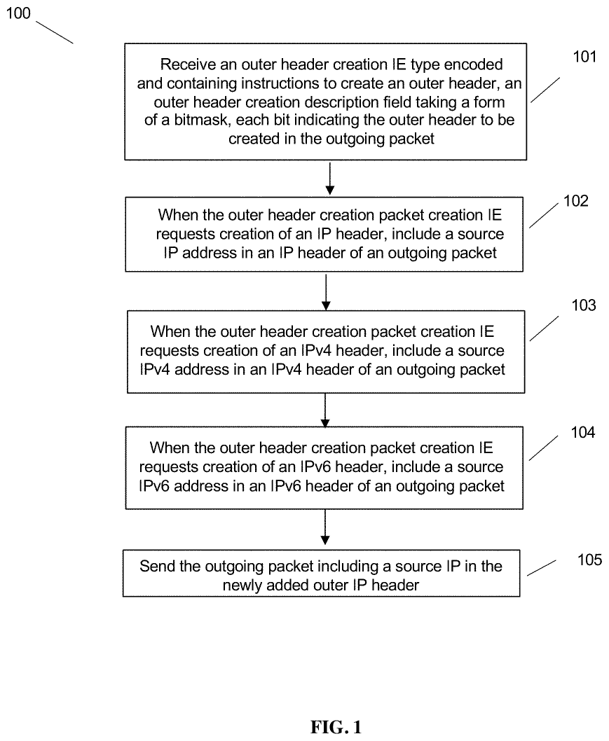

A flow chart of a particular embodiment of the presently disclosed method is depicted in FIG. 1. The rectangular elements denote “processing blocks” and represent computer software instructions or groups of instructions. Alternatively, the processing blocks may represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

FIG. 1 is a flowchart depicting one embodiment of a method 100 for creating an outer header for a packet. Process 100 begins with processing block 101 which recites receiving an outer header creation IE type encoded and containing instructions to create an outer header, an outer header creation description field taking a form of a bitmask, each bit indicating the outer header to be created in the outgoing packet.

Processing block 102 discloses wherein when the outer header creation packet creation IE requests creation of an IP header, a source IP address is included in an IP header of an outgoing packet.

Processing block 103 shows wherein when the outer header creation packet creation IE requests creation of an IPv4 header, a source IPv4 address is included in an IPv4 header of an outgoing packet.

Processing block 104 discloses wherein when the outer header creation packet creation IE requests creation of an IPv6 header, a source IPv6 address is included in an IPv4 header of an outgoing packet.

Processing block 105 states sending the outgoing packet including a source IP in the newly added outer IP header.

In some embodiments, the packet may be a SGW downlink packet; a SGW uplink packet; or a PGW uplink packet.

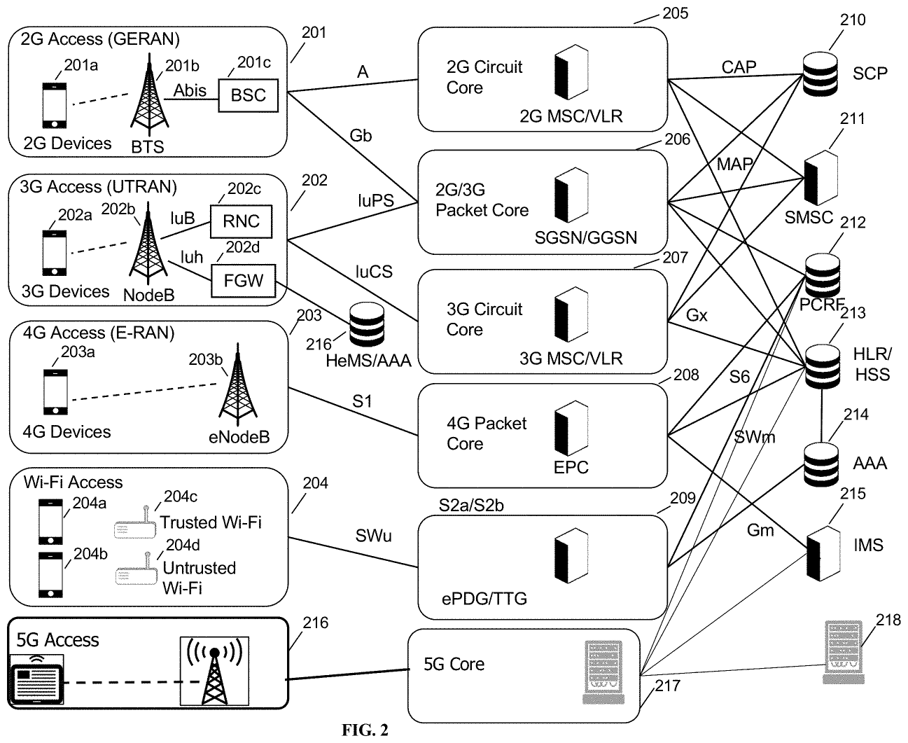

FIG. 2 is a schematic network architecture diagram for 3G and other-G prior art networks. The diagram shows a plurality of “Gs,” including 2G, 3G, 4G, 5G and Wi-Fi. 2G is represented by GERAN 201, which includes a 2G device 801a, BTS 201b, and BSC 201c. 3G is represented by UTRAN 202, which includes a 3G UE 202a, nodeB 202b, RNC 202c, and femto gateway (FGW, which in 3GPP namespace is also known as a Home nodeB Gateway or HNBGW) 202d. 4G is represented by EUTRAN or E-RAN 203, which includes an LTE UE 203a and LTE eNodeB 203b. Wi-Fi is represented by Wi-Fi access network 204, which includes a trusted Wi-Fi access point 204c and an untrusted Wi-Fi access point 204d. The Wi-Fi devices 204a and 204b may access either AP 204c or 204d. In the current network architecture, each “G” has a core network. 2G circuit core network 205 includes a 2G MSC/VLR; 2G/3G packet core network 206 includes an SGSN/GGSN (for EDGE or UMTS packet traffic); 3G circuit core 207 includes a 3G MSC/VLR; 4G circuit core 208 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 230, the SMSC 231, PCRF 232, HLR/HSS 233, Authentication, Authorization, and Accounting server (AAA) 234, and IP Multimedia Subsystem (IMS) 235. An HeMS/AAA 236 is present in some cases for use by the 3G UTRAN. The diagram is used to indicate schematically the basic functions of each network as known to one of skill in the art, and is not intended to be exhaustive. For example, 5G core 217 is shown using a single interface to 5G access 216, although in some cases 5G access can be supported using dual connectivity or via a non-standalone deployment architecture.

Noteworthy is that the RANs 201, 202, 203, 204 and 236 rely on specialized core networks 205, 206, 207, 208, 209, 237 but share essential management databases 230, 231, 232, 233, 234, 235, 238. More specifically, for the 2G GERAN, a BSC 201c is required for Abis compatibility with BTS 201b, while for the 3G UTRAN, an RNC 202c is required for Iub compatibility and an FGW 202d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

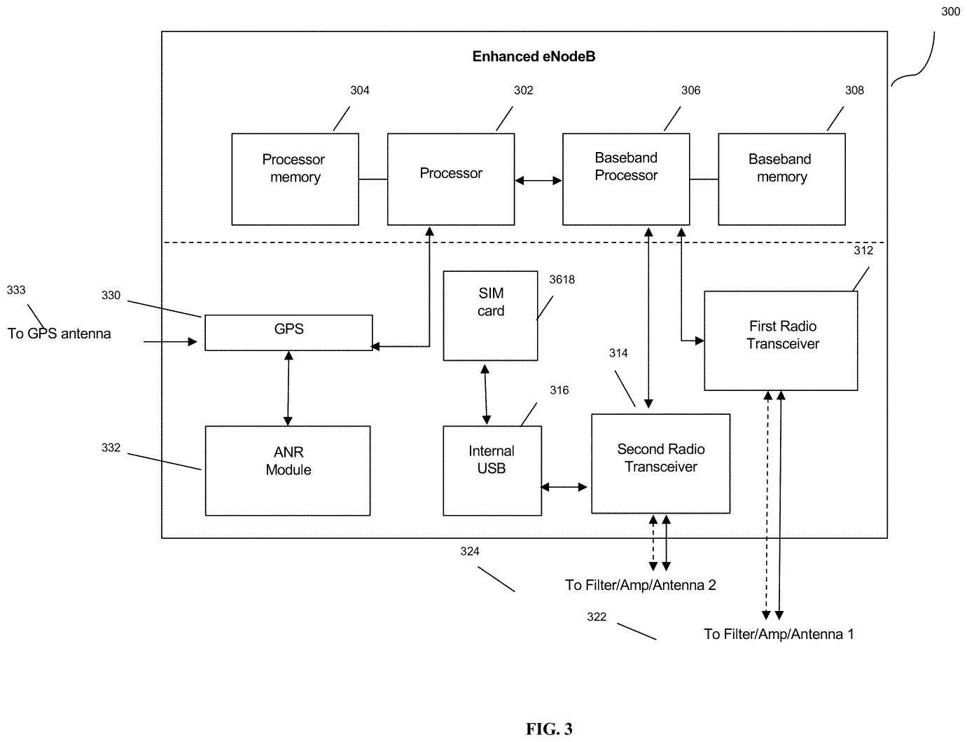

FIG. 3 is an enhanced eNodeB for performing the methods described herein, in accordance with some embodiments. Mesh network node 300 may include processor 302, processor memory 304 in communication with the processor, baseband processor 306, and baseband processor memory 308 in communication with the baseband processor. Mesh network node 300 may also include first radio transceiver 312 and second radio transceiver 314, internal universal serial bus (USB) port 316, and subscriber information module card (SIM card) 318 coupled to USB port 316. In some embodiments, the second radio transceiver 314 itself may be coupled to USB port 316, and communications from the baseband processor may be passed through USB port 316. The second radio transceiver may be used for wirelessly backhauling eNodeB 300.

Processor 302 and baseband processor 306 are in communication with one another. Processor 302 may perform routing functions, and may determine if/when a switch in network configuration is needed. Baseband processor 306 may generate and receive radio signals for both radio transceivers 312 and 314, based on instructions from processor 302. In some embodiments, processors 302 and 306 may be on the same physical logic board. In other embodiments, they may be on separate logic boards.

Processor 302 may identify the appropriate network configuration, and may perform routing of packets from one network interface to another accordingly. Processor 302 may use memory 304, in particular to store a routing table to be used for routing packets. Baseband processor 306 may perform operations to generate the radio frequency signals for transmission or retransmission by both transceivers 310 and 312. Baseband processor 306 may also perform operations to decode signals received by transceivers 312 and 314. Baseband processor 306 may use memory 308 to perform these tasks.

The first radio transceiver 312 may be a radio transceiver capable of providing LTE eNodeB functionality, and may be capable of higher power and multi-channel OFDMA. The second radio transceiver 314 may be a radio transceiver capable of providing LTE UE functionality. Both transceivers 312 and 314 may be capable of receiving and transmitting on one or more LTE bands. In some embodiments, either or both of transceivers 312 and 314 may be capable of providing both LTE eNodeB and LTE UE functionality. Transceiver 312 may be coupled to processor 302 via a Peripheral Component Interconnect-Express (PCI-E) bus, and/or via a daughtercard. As transceiver 314 is for providing LTE UE functionality, in effect emulating a user equipment, it may be connected via the same or different PCI-E bus, or by a USB bus, and may also be coupled to SIM card 318. First transceiver 312 may be coupled to first radio frequency (RF) chain (filter, amplifier, antenna) 322, and second transceiver 314 may be coupled to second RF chain (filter, amplifier, antenna) 324.

SIM card 318 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 300 is not an ordinary UE but instead is a special UE for providing backhaul to device 300.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 312 and 314, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 302 for reconfiguration.

A GPS module 330 may also be included, and may be in communication with a GPS antenna 332 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 332 may also be present and may run on processor 302 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

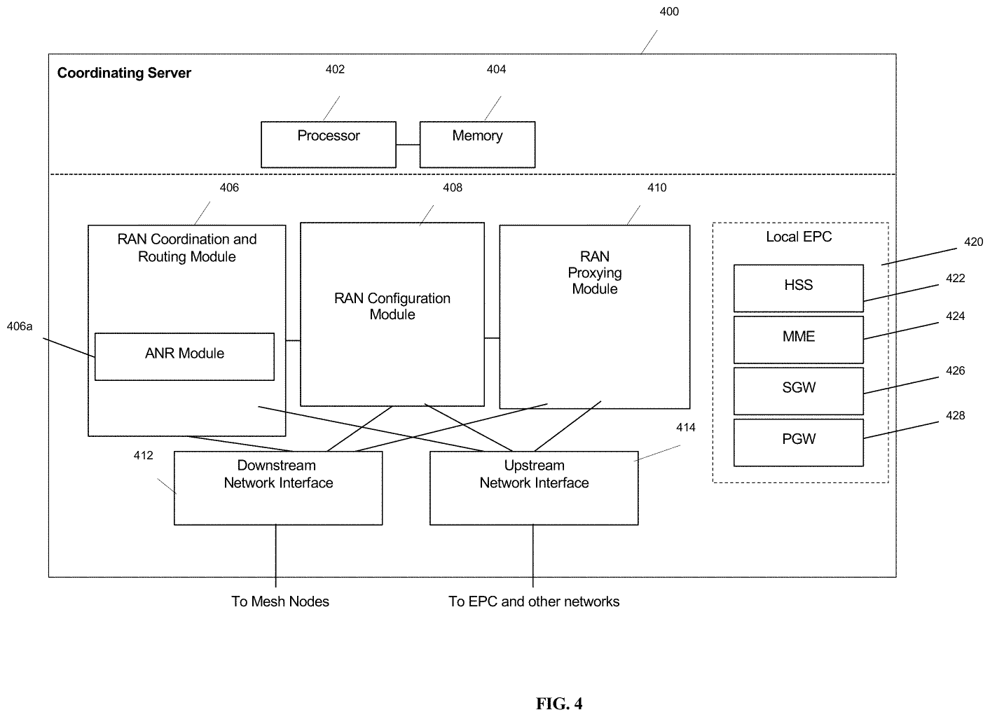

FIG. 4 is a coordinating server for providing services and performing methods as described herein, in accordance with some embodiments. Coordinating server 400 includes processor 402 and memory 404, which are configured to provide the functions described herein. Also present are radio access network coordination/routing (RAN Coordination and routing) module 406, including ANR module 406a, RAN configuration module 408, and RAN proxying module 410. The ANR module 406a may perform the ANR tracking, PCI disambiguation, ECGI requesting, and GPS coalescing and tracking as described herein, in coordination with RAN coordination module 406 (e.g., for requesting ECGIs, etc.). In some embodiments, coordinating server 400 may coordinate multiple RANs using coordination module 406. In some embodiments, coordination server may also provide proxying, routing virtualization and RAN virtualization, via modules 410 and 408. In some embodiments, a downstream network interface 412 is provided for interfacing with the RANs, which may be a radio interface (e.g., LTE), and an upstream network interface 414 is provided for interfacing with the core network, which may be either a radio interface (e.g., LTE) or a wired interface (e.g., Ethernet).

Coordinator 400 includes local evolved packet core (EPC) module 420, for authenticating users, storing and caching priority profile information, and performing other EPC-dependent functions when no backhaul link is available. Local EPC 420 may include local HSS 422, local MME 424, local SGW 426, and local PGW 428, as well as other modules. Local EPC 420 may incorporate these modules as software modules, processes, or containers. Local EPC 420 may alternatively incorporate these modules as a small number of monolithic software processes. Modules 406, 408, 410 and local EPC 420 may each run on processor 402 or on another processor, or may be located within another device.

In 5GC, the function of the SGW is performed by the SMF and the function of the PGW is performed by the UPF. The inventors have contemplated the use of the disclosed invention in 5GC as well as 5G/NSA and 4G. As applied to 5G/NSA, certain embodiments of the present disclosure operate substantially the same as the embodiments described herein for 4G. As applied to 5GC, certain embodiments of the present disclosure operate substantially the same as the embodiments described herein for 4G, except by providing an N4 communication protocol between the SMF and UPF to provide the functions disclosed herein.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof.

The word “cell” is used herein to denote either the coverage area of any base station, or the base station itself, as appropriate and as would be understood by one having skill in the art. For purposes of the present disclosure, while actual PCIs and ECGIs have values that reflect the public land mobile networks (PLMNs) that the base stations are part of, the values are illustrative and do not reflect any PLMNs nor the actual structure of PCI and ECGI values.

In the above disclosure, it is noted that the terms PCI conflict, PCI confusion, and PCI ambiguity are used to refer to the same or similar concepts and situations, and should be understood to refer to substantially the same situation, in some embodiments. In the above disclosure, it is noted that PCI confusion detection refers to a concept separate from PCI disambiguation, and should be read separately in relation to some embodiments. Power level, as referred to above, may refer to RSSI, RSFP, or any other signal strength indication or parameter.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols including 5G, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A method for creating an outer header for a packet, comprising:
receiving an outer header creation IE type encoded and containing instructions to create an outer header, an outer header creation description field taking a form of a bitmask, each bit indicating the outer header to be created in the outgoing packet;
wherein when the outer header creation packet creation IE requests creation of an IP header, a source IP address is included in an IP header of an outgoing packet; and
sending the outgoing packet including a source IP in the newly added outer IP header.

2. The method of claim 1 wherein when the outer header creation packet creation IE requests creation of an IPv4 header, a source IPv4 address is included in an IPv4 header of an outgoing packet.

3. The method of claim 1 wherein when the outer header creation packet creation IE requests creation of an IPv6 header, a source IPv6 address is included in an IPv6 header of an outgoing packet.

4. The method of claim 1 wherein the packet is a Serving Gateway (SGW) downlink packet.

5. The method of claim 1 wherein the packet is a Serving Gateway (SGW) uplink packet.

6. The method of claim 1 wherein the packet is a Packet Data Network (PDN) Gateway (PGW) uplink packet.

7. A non-transitory computer-readable medium containing instructions for creating an outer header for a packet which, when executed, cause a system to perform steps comprising:
receiving an outer header creation IE type encoded and containing instructions to create an outer header, an outer header creation description field taking a form of a bitmask, each bit indicating the outer header to be created in the outgoing packet;
wherein when the outer header creation packet creation IE requests creation of an IP header, a source IP address is included in an IP header of an outgoing packet; and
sending the outgoing packet including a source IP in the newly added outer IP header.

8. The computer-readable medium of claim 7 further comprising instructions wherein when the outer header creation packet creation IE requests creation of an IPv4 header, a source IPv4 address is included in an IPv4 header of an outgoing packet.

9. The computer-readable medium of claim 7 further comprising instructions wherein when the outer header creation packet creation IE requests creation of an IPv6 header, a source IPv6 address is included in an IPv6 header of an outgoing packet.

10. The computer-readable medium of claim 7 further comprising instructions wherein the packet is a Serving Gateway (SGW) downlink packet.

11. The computer-readable medium of claim 7 further comprising instructions wherein the packet is a Serving Gateway (SGW) uplink packet.

12. The computer-readable medium of claim 7 further comprising instructions wherein the packet is a Packet Data Network (PDN) Gateway (PGW) uplink packet.
